(19) United States
(12) Patent Application Publication
(10) Pub. No.: US 2017/0257219 A1
(43) Pub. Date: Sep. 7, 2017

(54) Application Code Obfuscating Apparatus And Method Of Obfuscating Application Code Using The Same

(71) Applicants: Ksign Co., Ltd., Seoul (KR); Soongsil University Research Consortium Techno-Park, Seoul (KR)

(72) Inventors: Jeong-Hyun Yi, Seongnam-si (KR); Yong-Jin Park, Seoul (KR); Sung-Eun Park, Suwon-si (KR)

(73) Assignees: Ksign Co., Ltd., Seoul (KR); Soongsil University Research Consortium Techno-Park, Seoul (KR)

(21) Appl. No.: 15/184,353

(22) Filed: Jun. 16, 2016

(30) Foreign Application Priority Data
Mar. 2, 2016 (KR) 10-2016-0024964

(51) Int. Cl. H04L 9/32; G06F 9/455; G06F 9/30

(52) U.S. Cl. CPC H04L 9/3247; G06F 9/30036; G06F 9/45529; G06F 9/45516

(57) ABSTRACT

An application code obfuscating apparatus includes a secret code divider, a secret code caller, a code converter and an obfuscating part. The secret code divider is configured to divide an application code having a first type into a secret code and a normal code. The secret code caller generating part is configured to generate a secret code caller to call the secret code. The code converter is configured to convert the secret code having the first type to a second type. The obfuscating part is configured to generate a first table and a second table. The first table includes an obfuscated signature of the secret code and a first random vector. The second table includes an offset of the secret code which corresponds to the obfuscated signature of the secret code and a second random vector which is liked with the first random vector.

### PRIORITY STATEMENT

This application claims priority under 35 U.S.C, §119 to Korean Patent Application No. 10-2016-0024964, filed on Mar. 2, 2016 in the Korean Intellectual Property Office (KIPO) the contents of which are herein incorporated by reference in their entireties.

### BACKGROUND

1. Technical Field

Exemplary embodiments relate to an application code obfuscating apparatus and a method of obfuscating an application code using the application code obfuscating apparatus. More particularly, exemplary embodiments relate to an application code obfuscating apparatus improving resistibility of reverse engineering and a method of obfuscating an application code using the application code obfuscating apparatus.

2. Description of the Related Art

In a conventional application code obfuscating apparatus and a method of obfuscating an application code for Java language, a code structure forming an application, which is executed on Java virtual machine, is changed to obfuscate the application code. Herein, the application before obfuscating includes an instruction set and an object file which are executed on Java virtual machine and the obfuscated application also includes an instruction set and an object file which are executed on Java virtual machine.

When the application is obfuscated by the conventional application code obfuscating apparatus and the conventional method, vulnerability of the reverse engineering of a managed code executed on the virtual machine may remain after obfuscating.

A compiled object code includes source code information such as a name of a class, a name of a member variable, a name of a method. In the compiled object code, the source code is explicitly structured so that a specific logic may be easily found and analyzed by the reverse engineering. Thus, the managed code may be vulnerable to the reverse engineering.

Android application includes object codes executed on Dalvik virtual machine similar to the application executed on the Java virtual machine and has a file type of .dex (Dalvik executable). Thus, the Android application may be vulnerable to the reverse engineering similar to the Java application.

### SUMMARY

Exemplary embodiments provide an application code obfuscating apparatus obfuscating an application code using a random vector table to improve resistibility of reverse engineering.

Exemplary embodiments also provide a method of obfuscating an application code using the application code obfuscating apparatus.

In an exemplary application code obfuscating apparatus according to the present inventive concept, the application code obfuscating apparatus includes a secret code divider, a secret code caller, a code converter and an obfuscating part. The secret code divider is configured to divide an application code having a first type into a secret code and a normal code. The secret code caller generating part is configured to generate a secret code caller to call the secret code. The code converter is configured to convert the secret code having the first type to a second type. The obfuscating part is configured to generate a first table and a second table. The first table includes an obfuscated signature of the secret code and a first random vector. The second table includes an offset of the secret code which corresponds to the obfuscated signature of the secret code and a second random vector which is liked with the first random vector.

In an exemplary embodiment, the first type may be a managed code. The second type may be a native code.

In an exemplary embodiment, the obfuscating part may include a code signature generator generating part configured to generate a code signature generator, a vector table divider generating part configured to generate a vector table divider and a random vector generator generating part configured to generate a random vector generator. The code signature generator may be configured to generate the obfuscated signature of the secret code. The vector table divider may be configured to dispose the obfuscated signature of the secret code in the first table and the offset of the secret code in the second table. The random vector generator may be configured to the first random vector disposed in the first table and the second random vector disposed in the second table

In an exemplary embodiment, the normal code and the secret code caller may be formed in a first code area, the first code area having the first type. The secret code, the code signature generator, the vector table divider and the random vector generator may be formed in a second code area, the second code area having the second type.

In an exemplary embodiment, the obfuscating part may further include a dummy code generator configured to generate a dummy code in the second code area.

In an exemplary embodiment, the code signature generator may be configured to further generate an obfuscated signature of the dummy code in the first table.

In an exemplary embodiment, the random vector generator may be configured to randomly generate the first random vector and the second random vector in each execution.

In an exemplary embodiment, when the secret code caller calls a secret code corresponding to a first signature using the first signature, the obfuscated signature of the secret code corresponding to the first signature may be selected from the first table, the first random vector which forms a pair with the selected signature may be selected, the second random vector corresponding to the first random vector may be selected from the second table, the offset of the secret code which forms a pair with the selected second random vector may be selected and the secret code may be called using the selected offset of the secret code.

In an exemplary method of obfuscating an application code according to the present inventive concept, the method includes dividing the application code having a first type into a secret code and a normal code, generating a secret code caller, the secret code caller configured to call the secret code, converting the secret code having the first type to a second type and generating a first table and a second table. The first table includes an obfuscated signature of the secret code and a first random vector. The second table includes an offset of the secret code which corresponds to the obfuscated signature of the secret code and a second random vector which is liked with the first random vector.

In an exemplary embodiment, the first type may be a managed code. The second type may be a native code.

In an exemplary embodiment, the generating the first table and the second table may include generating a code signature generator, the code signature generator configured to generate the obfuscated signature of the secret code, generating a vector table divider, the vector table divider configured to dispose the obfuscated signature of the secret code in the first table and the offset of the secret code in the second table and generating a random vector generator, the random vector generator configured to the first random vector disposed in the first table and the second random vector disposed in the second table.

In an exemplary embodiment, the normal code and the secret code caller may be formed in a first code area, the first code area having the first type. The secret code, the code signature generator, the vector table divider and the random vector generator may he formed in a second code area, the second code area having the second type.

In an exemplary embodiment, the method may further include generating a dummy code in the second code area.

In an exemplary embodiment, the generating the first table and the second table may further include generating an obfuscated signature of the dummy code in the first table.

In an exemplary embodiment, the random vector generator may be configured to randomly generate the first random vector and the second random vector in each execution.

In an exemplary embodiment, when the secret code caller calls a secret code corresponding to a first signature using the first signature, the obfuscated signature of the secret code corresponding to the first signature may be selected from the first table, the first random vector which forms a pair with the selected signature may be selected, the second random vector corresponding to the first random vector may be selected from the second table, the offset of the secret code which forms a pair with the selected second random vector may be selected and the secret code may be called using the selected offset of the secret code.

According to the application code obfuscating apparatus and a method of obfuscating application code using the application code obfuscating apparatus, the application obfuscating apparatus uses a divided vector table including a set of a first random vector and a divided offset table including a set of a second random vector so that the resistibility of the reverse engineering may be improved.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1 is a block diagram illustrating an application code obfuscating apparatus according to an exemplary embodiment of the present inventive concept;

FIG. 2 is a conceptual diagram illustrating an operation of the application code obfuscating apparatus of FIG 1;

FIG. 3 is a conceptual diagram illustrating an operation of a vector table generator, a vector table divider, a code signature generator and a random vector generator of FIG. 2;

FIG. 4A is a conceptual diagram illustrating an example of a divided vector table and an example of a divided offset table generated by the vector table generator, the vector table divider, the code signature generator and the random vector generator of FIG. 2; and

FIG. 4B is a conceptual diagram illustrating an example of a divided vector table and an example of a divided offset table generated by the vector table generator, the vector table divider, the code signature generator and the random vector generator of FIG. 2.

### DETAILED DESCRIPTION OF THE EMBODIMENTS

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set fourth herein.

Rather, these exemplary embodiments are provided so that this disclosure will he thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

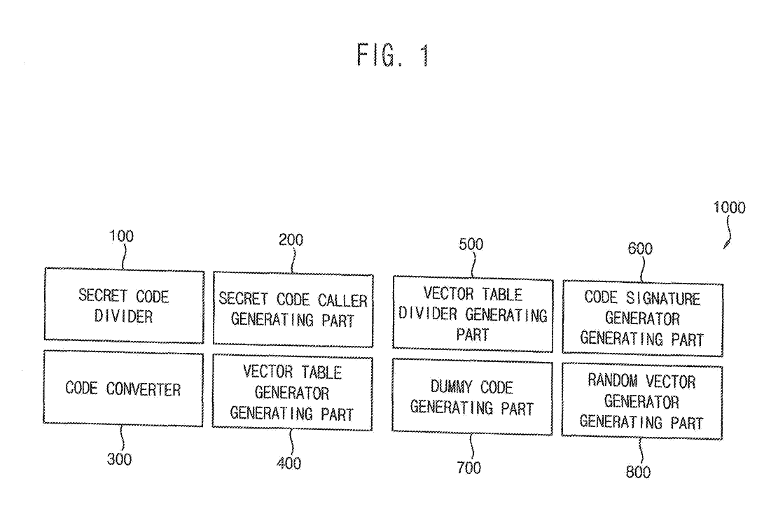

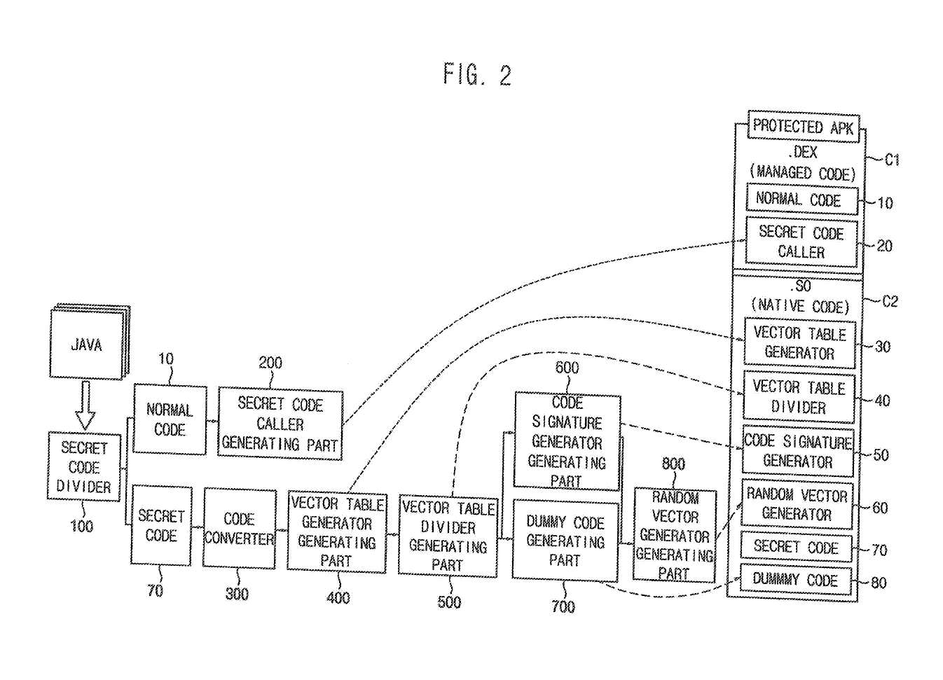

FIG. 1 is a block diagram illustrating an application code obfuscating apparatus according to an exemplary embodiment of the present inventive concept. FIG. 2 is a conceptual diagram illustrating an operation of the application code obfuscating apparatus of FIG. 1.

Referring to FIGS. 1 and 2, the application code obfuscating apparatus 1000 includes a secret code divider 100, a secret code caller generating part 200, a code converter 300 and an obfuscating part.

The obfuscating part includes a vector table generator generating part 400, a vector table divider generating part 500, a code signature generator generating part 600 and a random vector generator generating part 800. The obfuscating part may further include a dummy code generating part 700.

The secret code divider 100 receives an application code. The secret code divider 100 receives the application code having a first type. For example, the first type may be a managed code. The application code may be a Java code. For example, the application code may be a Dalvik executable (.dex).

The secret code divider 100 divides the application code into a secret code 70 and a normal code 10 except for the secret code 70. For example, the secret code 70 may mean the code required to be protected from forgery attack of the application. The normal code 10 is disposed in a managed code area C1.

The secret code caller generating part 200 generates a secret code caller 20. The secret code caller 20 may call the secret code 70 using a signature of the secret code 70. For example, the signature of the secret code 70 may be a parameter of a function.

For example, when the parameter used to call function A which is the secret code 70 is (integer, integer), the signature of the secret code 70 may be generated based on the parameter of (integer, integer). For example, when the parameter used to call function B which is the secret code 70 is (text, text, integer), the signature of the secret code 70 may be generated based on the parameter of (text, text, integer), Alternatively, the signature of the secret code 70 may be generated based on other information not based on the parameter of the function.

The secret code caller 20 generated by the secret code caller generating part 200 is disposed in the managed code area C1. The secret code caller 20 calls the secret code 70 disposed in a native code area C2 using the signature of the secret code 70.

The code converter 300 converts the secret code 70 of a first type to a second type. The first type may be the managed code. The second type may be the native code. The secret code 70 which is converted to the second type is disposed in the native code area C2. In the present exemplary embodiment, the secret code 70 is converted from the managed code, which is relatively explicit, to the native code, which is relatively implicit, so that the analysis complexity increases. In addition, methods of analysis of codes may be relatively applied to the managed code and the native code so that the analysis of codes may become hard.

The vector table generator generating part 400 generates a vector table generator 30. The vector table generator 30 may generate a dynamic vector table. The dynamic vector table includes the signatures of the secret codes 70 and offsets of the secret codes 70 corresponding to the signatures of the secret codes 70. The signature of the secret code 70 may mean an identifier for identifying the secret code 70. The offset of the secret code 70 may mean an address of the secret code 70 in the native code area C2. For example, the dynamic vector table may include a first column including the signatures of the secret codes 70 and a second column including the offsets of the secret codes 70. For example, the signature of the secret code 70 and the offset of the secret code 70 may have one to one correspondence relation.

The vector table generator 30 generated by the vector table generator generating part 400 may be disposed in the native code area C2.

The code signature generator generating part 600 generates a code signature generator 50. The code signature generator 50 may obfuscate the signature of the secret code 70. When the signature of the secret code 70 is obfuscated, the explicitness of the signature of the secret code 70 decreases so that the resistibility of analysis may increase.

The code signature generator 50 generated by the code signature generator generating part 600 may be disposed in the native code area C2.

The vector table divider generating part 500 generates a vector table divider generating part 40. The vector table divider generating part 40 divides the dynamic vector table generated by the vector table generator 30 into a first table and a second table.

The first table includes the signature of the secret code 70 and a first random vector. The second table includes the offset of the secret code 70 corresponding to the signature of the secret code 70 and a second random vector linked with the first random vector. For example, the first table may include the signature of the secret code 70 which is obfuscated by the code signature generator 50.

For example, the first table may include a first column including the signature of the secret code 70 and a second column including the first random vector.

For example, the second table may include a first column including the second random vector and a second column including the offset of the secret code 70.

In the present exemplary embodiment, the vector table generator 30 and the vector table divider 40 may operate independently. Alternatively, the vector table generator 30 and the vector table divider 40 may be integratedly formed so that the first table and the second table may be generated in a divided form.

In addition, in the present exemplary embodiment, the code signature generator 50 and the vector table generator 30 may operate independently. Alternatively, code signature generator 50 and the vector table generator 30 may be integratedly formed so that the obfuscated signature may be generated when the dynamic vector table is generated.

In addition, in the present exemplary embodiment, the code signature generator 50 and the vector table divider 40 may operate independently. Alternatively, code signature generator 50 and the vector table divider 40 may be integratedly formed so that the obfuscated signature may be generated in the first table when the first table and the second table are generated.

The dummy code generating part 700 may generate a dummy code 80 in the native code area C2. The dummy code 80 is a code for increasing complexity of obfuscation of the application code. When the dummy code 80 is disposed with the secret code 70 in the native code area C2, the resistibility of the analysis of the secret code 70 is increased.

The first table may further include a signature of the dummy code 80. The code signature generator 50 may obfuscate the signature of the dummy code 80.

The second table may include an offset of the dummy code 80 corresponding to the signature of the dummy code 80. When the application is executed, the dummy code 80 is not called. The signature of the dummy code 80 and the offset of the dummy code 80 increase the complexity of the first table and the second table so that the resistibility of the analysis of the first table and the second table is increased.

The random vector generator generating part 800 generates a random vector generator 60. The random vector generator 60 generates the first random vector disposed in the first table and the second random vector disposed in the second table.

The first random vector and the second random vector are randomly generated when the application is executed. In each execution of the application, the first random vector and the second random vector may vary. For example, the first random vector in a first execution of the application may be different from the first random vector in a second execution of the application.

The random vector generator 60 may generate the first and second random vectors of the secret code 70 and the first and second random vectors of the dummy code 80. For example, the random vector generator may generate the first and second random vectors of the secret code 70 and the first and second random vectors of the dummy code 80 without determining whether the code is the secret code 70 or the dummy code 80.

The random vector generator 60 generated by the random vector generator generating part 800 may be disposed in the native code area C2.

Referring to FIG. 2, the method of obfuscating the application code using the application code obfuscating apparatus is sequentially explained.

The secret code divider 100 receives the application code. The secret code divider 100 divides the application code into the secret code 70 and the normal code 10. The normal code 10 is disposed in a first code area C1.

The secret code caller generating part 200 generates the secret code caller 20. The secret code caller 20 is disposed in the first code area C1. When the application is executed, the secret code caller 20 may call the secret code 70 in a second code area C2 using the first table and the second table.

The secret code 70 which is divided by the secret code divider 100 is converted from the first code type into the second code type. The secret code 70 is disposed in the second code area C2.

The vector table generator generating part 400 generates the vector table generator 30. The vector table generator 30 generates the dynamic vector table including the signature of the secret code 70 and the offset of the secret code 70.

The vector table divider generating part 500 generates the vector table divider 40. The vector table divider 40 divides the dynamic vector table into the first table and the second table. The first table may include the signature of the secret code 70 and the first random vector. The second table may include the offset of the secret code 70 and the second random vector.

The code signature generator generating part 600 generates the code signature generator 50. The code signature generator 50 obfuscates the signature of the secret code 70. When the signature of the secret code 70 is obfuscated, the secret code 70 may not be analyzed by only the signature of the secret code 70.

The dummy code generating part 700 generates the dummy code 80. The dummy code 80 is disposed with the secret code 70 in the native code area C2 so that the resistibility of the analysis of the secret code 70 is increased. The generated dummy code 80 may be disposed in the first table and in the second table with the secret code 70.

The random vector generator generating part 800 generates the random vector generator 60. The random vector generator 60 generates the first random vector and the second random vector. The first random vector and the second random vector represent a reference index for linking the first table and the second table. In each execution of the application, the first random vector and the second random vector may vary.

The connectivity between the signature of the secret code 70 and the offset of the secret code 70 is weakened due to the first random vector and the second random vector. Thus, the resistibility of the analysis of the secret code 70 may increase.

In the present exemplary embodiment, the normal code 10 and the secret code caller 20 may be disposed in the first code area C1. In the present exemplary embodiment, the vector table generator 30, the vector table divider 40, the code signature generator 50, the random vector generator 60, the secret code 70 and the dummy code 80 may be disposed in the second code area C2.

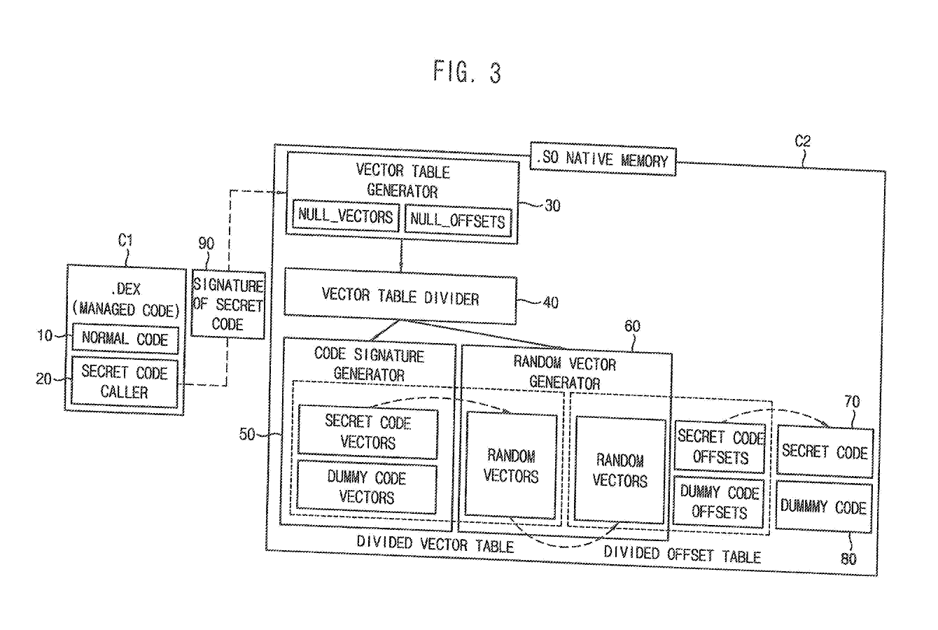

FIG. 3 is a conceptual diagram illustrating an operation of the vector table generator 30, the vector table divider 40, the code signature generator 50 and the random vector generator 60 of FIG. 2.

Referring to FIG. 3, herein a method of executing the application by a terminal of a client and a structure of an obfuscated application are explained. The steps of executing the application by the terminal are sequentially explained as follows.

The secret code caller 20 in the managed code area C1 calls the secret code 70 in the native code area C2 using the signature of the secret code 90.

In the native code area C2, in response to call of the secret code 70, the vector table generator 30 is called and the code signature generator 50 and the random vector generator 60 are called by the vector table divider 40.

The code signature generator 50 generates the signature of the secret code 70 and the signature of the dummy code 80 by obfuscating the signature of the secret code 70 and the signature of the dummy code 80. The generated signatures are used as secret code vectors of the first table (the divided vector table). Using the signature of the secret code from the secret code caller 20, the random vector corresponding to the secret code vector is determined.

The random vector generator 60 generates a random index and allocates the random index into the first table (the divided vector table) and the second table (the divided offset table).

The second table (the divided offset table) includes the offset of the secret code 70, the offset of the dummy code 80 and the second random vector. The offset of the secret code 70 corresponding to the first random vector which is referred from the first table (the divided vector table) is referred.

The offset selected by the second random vector is the offset of the secret code 70 which is called by the secret code caller 20. Using the offset of the secret code 70, the secret code 70 is executed.

Herein, the calling process of the secret code 70 is explained in detail. When the secret code caller 20 calls the secret code 70 corresponding to a first signature 90 using the first signature 90, the obfuscated signature of the secret code corresponding to the first signature 90 is selected from the first table and the first random vector which forms a pair with the selected signature is selected, the second random vector corresponding to the first random vector is selected from the second table, the offset of the secret code which forms a pair with the selected second random vector is selected and the secret code 70 is called using the selected offset of the secret code.

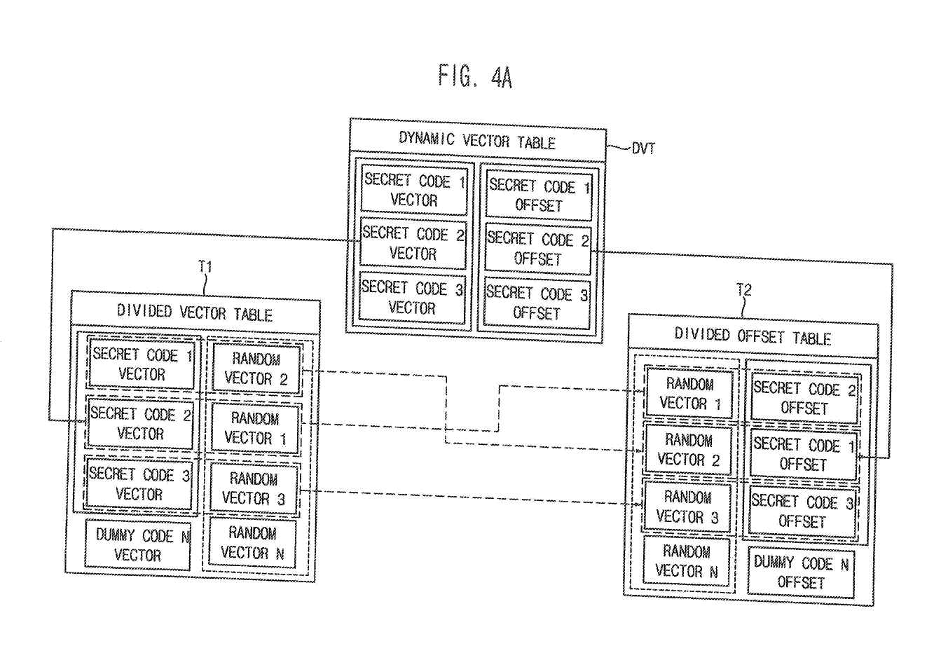

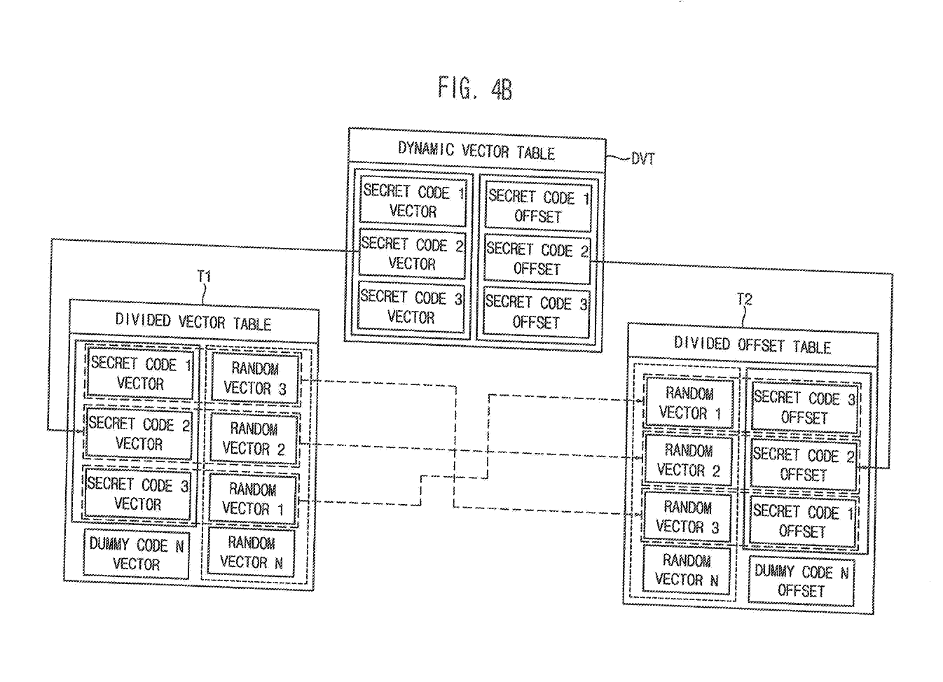

FIG. 4A is a conceptual diagram illustrating an example of the divided vector table and an example of the divided offset table generated by the vector table generator, the vector table divider, the code signature generator and the random vector generator of FIG. 2.

Referring to FIGS. 1 to 4A, the obfuscating part of the present exemplary embodiment divides a dynamic vector table DVT including the signatures of the secret codes SECRET CODE 1 VECTOR, SECRET CODE 2 VECTOR and SECRET CODE 3 VECTOR and address offsets SECRET CODE 1 OFFSET, SECRET CODE 2 OFFSET and SECRET CODE 3 OFFSET corresponding to the signatures of the secret codes into the vector table T1 and the offset table T2. The vector table T1 includes the signatures of the secret codes SECRET CODE 1 VECTOR, SECRET CODE 2 VECTOR and SECRET CODE 3 VECTOR and first random vectors RAMDOM VECTOR 2, RANDOM VECTOR 1 and RANDOM VECTOR 3. The offset table T2 includes second random vectors RAMDOM VECTOR 1, RANDOM VECTOR 2 and RANDOM VECTOR 3 and the address offsets SECRET CODE 2 OFFSET, SECRET CODE 1 OFFSET and SECRET CODE 3 OFFSET of the secret codes.

When the dynamic vector table DVT is divided into the vector table T1 and the offset table T2, the signature DUMMY CODE N VECTOR of the dummy code and the offset DUMMY CODE N OFFSET of the dummy code corresponding to the signature of the dummy code may be added to the divided tables T1 and T2.

When the secret code is called, the obfuscated signature is used as the vector of the secret code and the random vector corresponding to the vector of the secret code may be obtained.

Using the obtained random vector, the offset of the secret code may be obtained from the offset table. Using the offset of the secret code, the secret code is executed.

For example, when SECRET CODE 1 is called, RANDOM VECTOR 2 which forms a pair with the SECRET CODE 1 VECTOR is selected from the vector table T1 (e.g. in a first row of the vector table T1). A location of the selected RANDOM VECTOR 2 is searched from the offset table T2 (e.g. in a second row of the offset table T2). The SECRET CODE 1 OFFSET which forms a pair with the RANDOM VECTOR 2 is obtained. Using the SECRET CODE 1 OFFSET, the SECRET CODE 1 is executed.

For example, when SECRET CODE 2 is called, RANDOM VECTOR 1 which forms a pair with the SECRET CODE 2 VECTOR is selected from the vector table T1 (e.g. in a second row of the vector table T1). A location of the selected RANDOM VECTOR 1 is searched from the offset table T2 (e.g. in a first row of the offset table T2). The SECRET CODE 2 OFFSET which forms a pair with the RANDOM VECTOR 1 is obtained. Using the SECRET CODE 2 OFFSET, the SECRET CODE 2 is executed.

A method of forming rows in the vector table T1 and the offset table T2 is not limited the above explained method. Although the sequence of the rows of the first random vectors RANDOM VECTOR 2, RANDOM VECTOR 1 and RANDOM VECTOR 3 in the vector table T1 is different from the sequence of the rows of the second random vectors RANDOM VECTOR 1, RANDOM VECTOR 2 and RANDOM VECTOR 3 in the offset table T2 in FIG. 4A, the sequence of the rows of the first random vectors in the vector table T1 may be same as the sequence of the rows of the second random vectors in the offset table T2.

FIG. 4B is a conceptual diagram illustrating an example of a divided vector table, a divided offset table generated by the vector table generator, the vector table divider, the code signature generator and the random vector generator of FIG. 2.

Referring to FIGS. 1 to FIG. 4B, the random vector generator 60 may randomly generate the first random vectors and the second random vectors in each execution.

For example, the first random vectors and the second random vectors in FIG. 4B are different from the first random vectors and the second random vectors in FIG. 4A.

For example, when SECRET CODE 1 is called, RANDOM VECTOR 3 which forms a pair with the SECRET CODE 1 VECTOR is selected from the vector table T1 (e.g. in a first row of the vector table T1). A location of the selected RANDOM VECTOR 3 is searched from the offset table T2 (e.g. in a third row of the offset table T2). The SECRET CODE 1 OFFSET which forms a pair with the RANDOM VECTOR 3 is obtained. Using the SECRET CODE 1 OFFSET, the SECRET CODE 1 is executed.

For example, when SECRET CODE 2 is called, RANDOM VECTOR 2 which forms a pair with the SECRET CODE 2 VECTOR is selected from the vector table T1 (e.g. in a second row of the vector table T1). A location of the selected RANDOM VECTOR 2 is searched from the offset table T2 (e.g. in a second row of the offset table T2). The SECRET CODE 2 OFFSET which forms a pair with the RANDOM VECTOR 2 is obtained. Using the SECRET CODE 2 OFFSET, the SECRET CODE 2 is executed.

According to the present exemplary embodiment, the dynamic vector table DVT for executing the secret code is divided into the vector table T1 and the offset table T2 so that analysis of the flow of calling the secret code may become difficult so that resistibility of static analysis may be increased.

In addition, the divided vector table T1 and the divided offset table T2 are linked using random vectors in each execution. Thus, the flow of calling the secret code may vary in each execution so that resistibility of dynamic analysis may be increased.

In addition, the signature of the secret code in the vector table T1 is obfuscated so that the analysis of the secret code using only the vector table T1 may become difficult so that resistibility of static analysis may be increased.

In addition, when dividing the dynamic vector table DVT into the divided vector table T1 and the divided offset table T2, the signature of the dummy code and the offset of the dummy code are inserted in the divided vector table T1 and the divided offset table T2 so that analysis of the flow of calling the secret code may become difficult so that resistibility of dynamic analysis may be increased.

The present inventive concept may be employed to any electric devices operating application code obfuscation. The electric devices may be one of a cellular phone, a smart phone, a laptop computer, a tablet computer, a digital broadcasting terminal, a PDA, a PMP, a navigation device, a digital camera, a camcorder, a digital television, a set top box, a music player, a portable game console, a smart card, a printer, etc.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. An application code obfuscating apparatus comprising:
a secret code divider configured to divide an application code having a first type into a secret code and a normal code;
a secret code caller generating part configured to generate a secret code caller to call the secret code;
a code converter configured to convert the secret code having the first type to a second type; and
an obfuscating part configured to generate a first table and a second table, the first table including an obfuscated signature of the secret code and a first random vector, the second table including an offset of the secret code which corresponds to the obfuscated signature of the secret code and a second random vector which is liked with the first random vector.

2. The application code obfuscating apparatus of claim 1, wherein the first type is a managed code, and
the second type is a native code.

3. The application code obfuscating apparatus of claim 1, wherein the obfuscating part comprises:
a code signature generator generating part configured to generate a code signature generator, the code signature generator configured to generate the obfuscated signature of the secret code;
a vector table divider generating part configured to generate a vector table divider, the vector table divider configured to dispose the obfuscated signature of the secret code in the first table and the offset of the secret code in the second table; and
a random vector generator generating part configured to generate a random vector generator, the random vector generator configured to the first random vector disposed in the first table and the second random vector disposed in the second table.

4. The application code obfuscating apparatus of claim 3, wherein the normal code and the secret code caller are formed in a first code area, the first code area having the first type, and
the secret code, the code signature generator, the vector table divider and the random vector generator are formed in a second code area, the second code area having the second type.

5. The application code obfuscating apparatus of claim 4, wherein the obfuscating part further comprises a dummy code generator configured to generate a dummy code in the second code area.

6. The application code obfuscating apparatus of claim 5, wherein the code signature generator is configured to further generate an obfuscated signature of the dummy code in the first table.

7. The application code obfuscating apparatus of claim 3, wherein the random vector generator is configured to randomly generate the first random vector and the second random vector in each execution.

8. The application code obfuscating apparatus of claim 3, wherein when the secret code caller calls a secret code corresponding to a first signature using the first signature, the obfuscated signature of the secret code corresponding to the first signature is selected from the first table, the first random vector which forms a pair with the selected signature is selected, the second random vector corresponding to the first random vector is selected from the second table, the offset of the secret code which forms a pair with the selected second random vector is selected and the secret code is called using the selected offset of the secret code.

9. A method of obfuscating an application code, the method comprising:
dividing the application code having a first type into a secret code and a normal code;
generating a secret code caller, the secret code caller configured to call the secret code;
converting the secret code having the first type to a second type; and
generating a first table and a second table, the first table including an obfuscated signature of the secret code and a first random vector, the second table including an offset of the secret code which corresponds to the obfuscated signature of the secret code and a second random vector which is liked with the first random vector.

10. The method of claim 9, wherein the first type is a managed code, and the second type is a native code.

11. The method of claim 9, wherein the generating the first table and the second table comprises:
generating a code signature generator, the code signature generator configured to generate the obfuscated signature of the secret code;
generating a vector table divider, the vector table divider configured to dispose the obfuscated signature of the secret code in the first table and the offset of the secret code in the second table; and
generating a random vector generator, the random vector generator configured to the first random vector disposed in the first table and the second random vector disposed in the second table.

12. The method claim 11, wherein the normal code and the secret code caller are formed in a first code area, the first code area having the first type, and
the secret code, the code signature generator, the vector table divider and the random vector generator are formed in a second code area, the second code area having the second type.

13. The method of claim 12, further comprising generating a dummy code in the second code area.

14. The method claim 13, wherein the generating the first table and the second table further comprising generating an obfuscated signature of the dummy code in the first table.

15. The method of claim 11, wherein the random vector generator is configured to randomly generate the first random vector and the second random vector in each execution.

16. The method of claim 11, wherein when the secret code caller calls a secret code corresponding to a first signature using the first signature, the obfuscated signature of the secret code corresponding to the first signature is selected from the first table, the first random vector which forms a pair with the selected signature is selected, the second random vector corresponding to the first random vector is selected from the second table, the offset of the secret code which forms a pair with the selected second random vector is selected and the secret code is called using the selected offset of the secret code.
